(19) United States
(12) Patent Application Publication
(10) Pub. No.: US 2017/0175848 A1
(43) Pub. Date: Jun. 22, 2017

(54) TORSIONAL DAMPER ASSEMBLY

(71) Applicants: Adam Timmons, Royal Oak, MI (US); Gregory Heitmann, Shelby Township, MI (US)

(72) Inventors: Adam Timmons, Royal Oak, MI (US); Gregory Heitmann, Shelby Township, MI (US)

(21) Appl. No.: 14/978,322

(22) Filed: Dec. 22, 2015

(51) Int. Cl. F16F 15/123; F16D 3/12

(52) U.S. Cl. CPC F16F 15/12353; F16D 3/12

(57) ABSTRACT

A torsional damper assembly for a vehicle powertrain is provided and is configured to dampen torsional vibration transfer between an engine and a transmission of the vehicle. The assembly includes a hub having a flange defining a window, a biasing mechanism disposed at least partially within the window and configured to absorb a first portion of the torsional vibration from the engine, and a damper body disposed at least partially within the window. The damper body is formed from at least one of a viscoelastic material and a viscoplastic material, and is configured to dampen a second, different portion of the torsional vibration and radial forces from the engine such that the biasing mechanism and the damper body cooperatively dampen the torsional vibration transfer between the engine and the transmission.

### FIELD

The present application relates generally to a torsional damper assembly for a vehicle powertrain and, more particularly, to a torsional damper assembly having a viscoelastic and/or viscoplastic damper element.

### BACKGROUND

Conventional torsional damper assemblies typically include a hub, plate members disposed on opposing sides of the hub, and torque transmitting coil springs. Each plate member includes at least one generally rectangular window in which a coil spring is disposed, and raised portions formed in the plate members to maintain the coil spring in the window. When the plate members and the hub are rotated relative to each other, the coil springs are compressed within the window and absorb torsional vibration. The spring rate of the coil is chosen such that the springs do not bottom out during the engine to transmission inertial coupling. However, the coil springs only provide one dimension of torsional vibration tunability. The selection of spring rates cannot be chosen to independently avoid forced oscillations that may cause false diagnostic detections and potentially unwanted mechanical wear. Accordingly, while such conventional torsional damper assemblies work for their intended purpose, it is desirable to provide an improved assembly with additional dampening capability.

### SUMMARY

According to one exemplary aspect of the invention, a torsional damper assembly for a vehicle powertrain is provided. The torsional damper assembly is configured to dampen torsional vibration and radial force transfer between an engine and a transmission of the vehicle. In one example implementation, the torsional damper assembly includes a hub having a flange defining a window, a damper body disposed at least partially within the window, and an elastic biasing mechanism disposed at least partially within the window. The damper body is fabricated from at least one of a viscoelastic material and a viscoplastic material, and is configured to dampen a first portion of the torsional vibration from the engine as well as radial forces from the engine to thereby reduce forced oscillation energy. The elastic biasing mechanism is operatively associated with the damper body and is configured to absorb a second, different portion of the torsional vibration from the engine such that the damper body and elastic biasing mechanism cooperatively dampen the torsional vibration transfer between the engine and the transmission.

In some implementations the elastic biasing mechanism is an elastic coil spring. In one implementation, the damper body is disposed within the spring. In other implementations, the damper body is a tubular sleeve and the damper body is spring is disposed within the sleeve. In another implementation, the spring is embedded within the damper body.

In some implementations, the spring has a length greater than the damper body, and in other implementations the spring and damper body have equal lengths. In one implementation, the spring includes a length less than the damper body.

In some implementations, the torsional damper assembly also includes first and second plates operatively associated with the hub and including a first plate window and a second plate window, respectively, wherein the first and second plate windows are each configured to at least partially align with the hub window. In one implementation, the first and second windows are configured to receive at least a portion of the damper body and biasing mechanism.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a front view of an example torsional damper assembly in accordance with the principles of the present disclosure;

FIG. 2 is a cross-sectional view of the torsional damper assembly in FIG. 1 taken along line 2-2 in accordance with the principles of the present disclosure;

FIG. 3 is a side view of an example damper element that may be used in the assembly of FIG. 1 in accordance with the principles of the present disclosure;

FIG. 4 is a side view of another example damper element that may be used in the assembly of FIG. 1 in accordance with the principles of the present disclosure;

FIG. 5 is a side view of yet another example damper element that may be used in the assembly of FIG. 1 in accordance with the principles of the present disclosure;

FIG. 6 is a side view of yet another example damper element that may be used in the assembly of FIG. 1 in accordance with the principles of the present disclosure;

FIG. 7 is a side view of yet another example damper element that may be used in the assembly of FIG. 1 in accordance with the principles of the present disclosure;

FIG. 8 is a side view of yet another example damper element that may be used in the assembly of FIG. 1 in accordance with the principles of the present disclosure; and

FIG. 9 is a side view of yet another example damper element that may be used in the assembly of FIG. 1 in accordance with the principles of the present disclosure.

### DETAILED DESCRIPTION

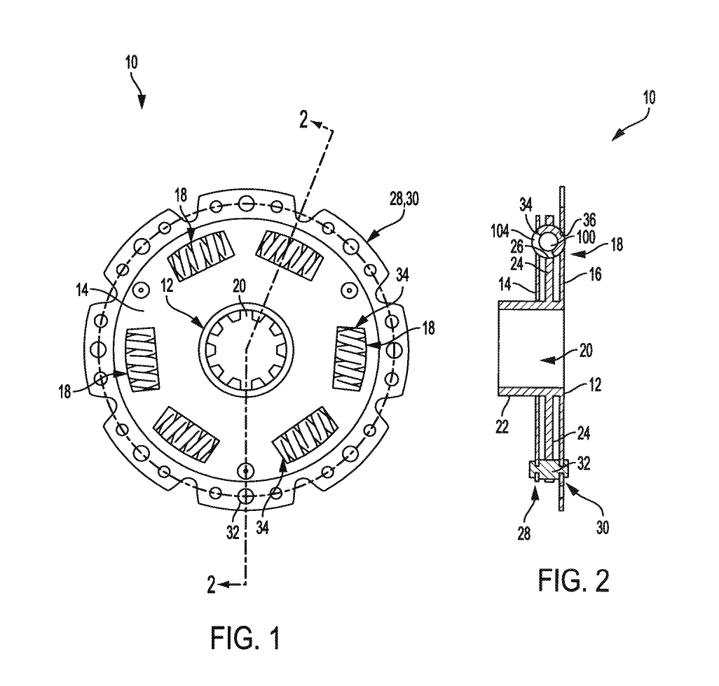

With initial reference to FIGS. 1 and 2, an example torsional damper assembly of a vehicle is illustrated and generally identified at reference numeral 10. Torsional damper assembly 10 may be disposed between a vehicle engine and transmission (not shown) and configured to smooth torsional vibration behavior of the engine before it is transferred to the transmission. In one example, torsional damper assembly 10 is utilized with a hybrid powertrain (not shown) and thus the associated vehicle may not require a torque converter. In some implementations, a torque converter is used in automatic transmission applications to decouple the engine from the transmission. Such a torque converter may operate through the flow of hydraulic fluid from an impeller to a turbine inside the torque converter, which causes centrifugal force that produces torque to the transmission.

In an example implementation, torsional damper assembly 10 generally includes a hub 12, a first disc or plate 14, a second disc or plate 16, and at least one damper element 18. In the example implementation, hub 12 includes an internal aperture 20, an outer circumferential surface 22, a radially extending flange 24, and one or more windows 26. Internal aperture 20 is configured to receive an input shaft (not shown) of the transmission. For example, internal aperture 20 may be configured for a splined connection with the input shaft. Flange 24 extends radially outward from the outer circumferential surface 22. Windows 26 are configured to receive and secure a damper element 18 therein. In alternative implementations, damper elements 18 may be configured on the external perimeter of the hub 12 and secured in place, for example, by end stops (not shown).

First plate 14 and second plate 16 function as input members and are rotatably engaged with the outer circumferential surface 22 of hub 12. First and second plates 14, 16 are disposed on either side of hub flange 24, and are rotatable relative to one another and to hub flange 24. Plates 14, 16 may be fixed to each other at their respective outer circumferential portions 28, 30 by a plurality of pins 32, which are configured to limit the relative rotation between plates 14, 16. First plate 14 may include one or more windows 34 configured to align with at least a portion of an associated window 26 and receive at least a portion of the damper element 18 within the window 34. Similarly, second plate 16 may include one or more windows 36 configured to align with at least a portion of an associated window 26 and receive at least a portion of the damper element 18 within the window 36.

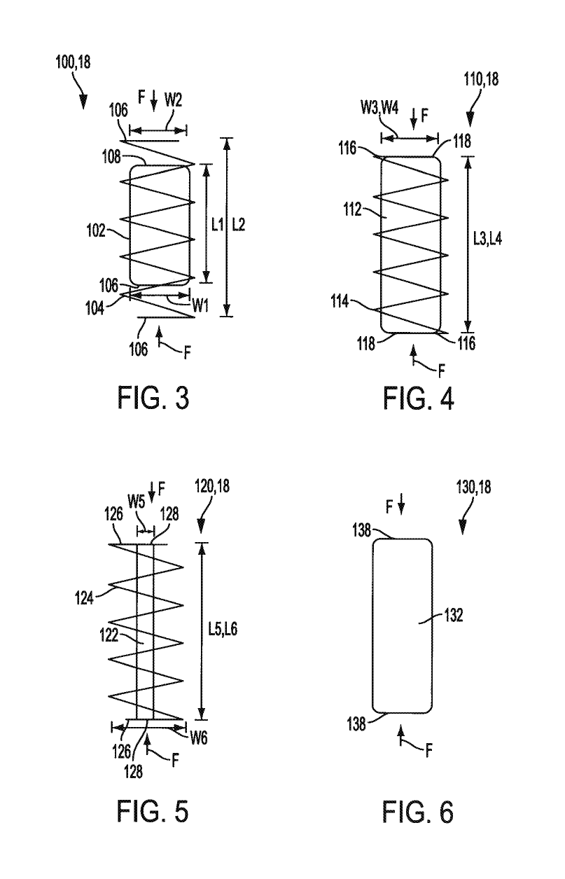

Damper element 18 is deformable in response to relative angular displacement between hub 12, first plate 14, and/or second plate 16. In the example implementation, at least a portion of damper element 18 is fabricated from a viscoelastic and/or a viscoplastic material. As such, under a force, damper element 18 may initially behave like a spring. If enough force is applied, the damper element 18 may then partially deform to adopt a new shape that acts as a secondary stage of damping and reduces the damper element's reaction force. However, due to the viscoelastic/viscoplastic material, the deformation is reversible and not permanent. Accordingly, damper element 18 is configured to provide an additional tunability factor or dimension beyond typical friction force and spring force factors. FIGS. 3-9 illustrate various configurations of the damper element 18 in more detail.

The viscoelastic/viscoplastic material of damper element 18 is configured to dampen torsional vibration and radial forces through the input shaft from the engine. As such, when these vibrations and forces act on damper element 18, the viscoelastic/viscoplastic material reduces the amplitude of the oscillation and controls the impact from the force by absorbing some of the energy, which reduces the torsional behavior from the engine before it travels to the transmission.

In the various implementations described herein, the viscoelastic/viscoplastic material acts like a spring due to its ability to deform and then return to its original shape without permanent deformation. The viscoelastic/viscoplastic material acts like a dashpot due to its ability to deform and return to its original shape at different rates of time, whereas conventional torsional dampers have friction plates that absorb some of the energy but do not act as dashpots because friction does not recover displacement.

In some implementations, damper element 18 also includes a biasing mechanism such as a spring. The spring is configured to absorb only a portion of the torsional vibration from the engine. However, the spring alone cannot provide damping, which is provided by the viscoelastic/viscoplastic material. Springs have elastic responses whereas the viscoelastic/viscoplastic materials have both spring-like elastic and dashpot-like viscus responses. For elastic responses, s=Ee where s is stress, e is strain, and E is their modulus. For viscus responses, s=n*de/dt where n is the viscosity, as is understood by those skilled in the art. In these implementations where both a spring and a damper element are utilized, the spring can be configured to react or damper a first portion or stage of the torsional vibration or load, and then if enough (i.e., greater) load is applied, the damper element can provide a secondary stage of damping for a second portion of the torsional vibration and also the radial forces to reduce/eliminate forced oscillations.

A viscoelastic material, as used herein, is a name given to a class of materials that displays a stretching or elongation response usually referred to as a strain to an external stress that is dependent on the initial stress, on the strain, and on either the time rate of application of the stress or the time rate of change of the strain. These materials usually exhibit a time lag in the strain relative to the stress and usually exhibit creep under a constant applied stress. For example, some typical viscoelastic materials usable in constrained layer damping include RTV materials such as silicone rubber, or poly-norborene rubber. As used herein, the term viscoplastic is a property in which a material behaves like a solid below some critical stress value, the yield stress, but flows like a viscous liquid when this stress is exceeded.

FIG. 3 illustrates a damper element 100 that includes a viscoelastic/viscoplastic rod or body 102 and a biasing mechanism 104. In the example implementation, body 102 is generally cylindrical and is fabricated from a viscoelastic and/or viscoplastic material, and biasing mechanism 104 is a coil spring. Viscoelastic/viscoplastic body 102 is disposed within the biasing mechanism 104 and includes a diameter or width ‘W1’ that is equal to or substantially equal to an internal diameter or width ‘W2’ of biasing mechanism 104. Body 102 further includes a length ‘L1’ that is less than a length ‘L2’ of biasing mechanism 104. As such, when a force ‘F’ acts upon ends 106 of the biasing mechanism 104, damper element 100 behaves like a spring for a distance ‘D1’ until the force ‘F’ acts upon ends 108 of the viscoelastic/viscoplastic body 102. At this point, the behavior of damper element 100 includes both spring response characteristics and viscoelastic/viscoplastic response characteristics.

FIG. 4 illustrates a damper element 110 that includes a viscoelastic/viscoplastic rod or body 112 and a biasing mechanism 114. In the example implementation, body 112 has a generally cylindrical shape and is fabricated from a viscoelastic and/or viscoplastic material, and biasing mechanism 114 is a coil spring. Viscoelastic/viscoplastic body 112 is disposed within the biasing mechanism 114 and includes a diameter or width ‘W3’ that is equal to or substantially equal to an inner diameter or width ‘W4’ of biasing mechanism 114. Body 112 further includes a length ‘L3’ that is equal to or substantially equal to a length ‘L4’ of biasing mechanism 114. As such, when a force ‘F’ acts upon ends 116 of biasing mechanism 114 and ends 118 of body 112, the behavior of damper element 110 includes both spring response characteristics and viscoelastic/viscoplastic response characteristics.

FIG. 5 illustrates a damper element 120 that includes a viscoelastic/viscoplastic band or body 122 and a biasing mechanism 124. In the example implementation, body 122 is fabricated from a viscoelastic and/or viscoplastic material, and biasing mechanism 124 is a coil spring. Viscoelastic/viscoplastic body 122 is disposed within the biasing mechanism 124 and includes a diameter or width ‘W5’ that is less than an inner diameter or width ‘W6’ of biasing mechanism 124. Body 122 further includes a length ‘L5’ that is equal to or substantially equal to a length ‘L6’ of biasing mechanism 124. As such, when a force ‘F’ acts upon ends 126 of biasing mechanism 124 and ends 128 of body 122, the behavior of damper element 120 includes both spring response characteristics and viscoelastic/viscoplastic response characteristics.

FIG. 6 illustrates a damper element 130 that only includes a viscoelastic/viscoplastic rod or body 132 and does not include a biasing mechanism such as a coil spring. In the example implementation, body 132 has a generally cylindrical shape and is fabricated from a viscoelastic and/or viscoplastic material. As such, when a force ‘F’ acts upon ends 138 of body 132, the behavior of damper element 132 includes viscoelastic/viscoplastic response characteristics, which include spring-like properties.

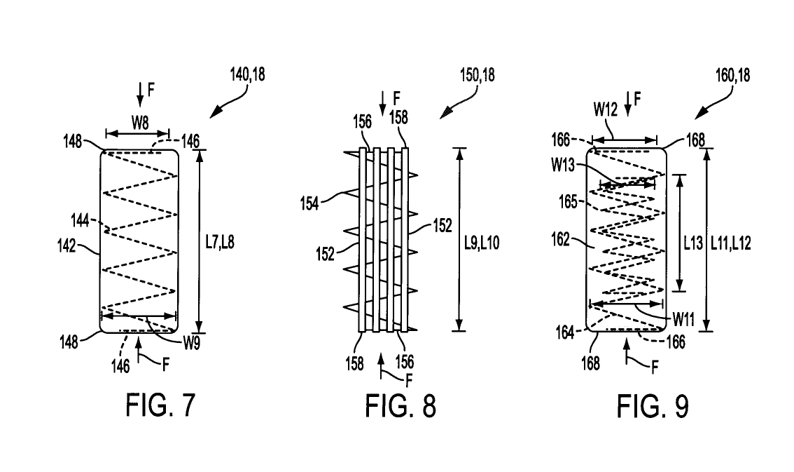

FIG. 7 illustrates a damper element 140 that includes a viscoelastic/viscoplastic sleeve or body 142 and a biasing mechanism 144. In the example implementation, body 142 has a generally cylindrical tubular shape and is fabricated from a viscoelastic and/or viscoplastic material, and biasing mechanism 144 is a coil spring. In the illustrated example, biasing mechanism 144 is disposed within the viscoelastic/viscoplastic sleeve 142 and includes an outer diameter or width ‘W7’ that is equal to or substantially equal to inner diameter or width ‘W8’ of sleeve 142. Viscoelastic/viscoplastic sleeve 142 further includes a length ‘L7’ that is equal to or substantially equal to a length 18′ of biasing mechanism 144. As such, when a force ‘F’ acts upon ends 146 of biasing mechanism 144 and ends 148 of sleeve 142, the behavior of damper element 140 includes both spring response characteristics and viscoelastic/viscoplastic response characteristics. Alternatively, body 142 can be solid rather than tubular and biasing mechanism 144 may be embedded therein.

FIG. 8 illustrates a damper element 150 that includes at least one viscoelastic/viscoplastic band or body 152 and a biasing mechanism 154. In the example implementation, damper element 150 includes a plurality of viscoelastic/viscoplastic bands 152 fabricated from a viscoelastic and/or viscoplastic material, and biasing mechanism 144 is a coil spring. In the illustrated example, viscoelastic/viscoplastic bands 152 are disposed around an outer diameter surface 155 of biasing mechanism 154. The bands 152 may be spaced evenly about a circumference of surface 155. Viscoelastic/viscoplastic bands 152 each include a length ‘L9’ that is equal to or substantially equal to a length ‘L10’ of biasing mechanism 154. As such, when a force ‘F’ acts upon ends 156 of biasing mechanism 154 and ends 158 of bands 152, the behavior of damper element 150 includes both spring response characteristics and viscoelastic/viscoplastic response characteristics.

FIG. 9 illustrates a damper element 160 that includes a viscoelastic/viscoplastic sleeve or body 162, a first biasing mechanism 164, and a second biasing mechanism 165. In the example implementation, sleeve 162 has a generally cylindrical tubular shape and is fabricated from a viscoelastic and/or viscoplastic material, and biasing mechanisms 164, 165 are coil springs. In the illustrated example, first biasing mechanism 164 is disposed within the viscoelastic/viscoplastic sleeve 162 and includes a diameter or width ‘W11’ that is equal to or substantially equal to an inner diameter or width ‘W12’ of sleeve 162. Second biasing mechanism 165 is disposed within first biasing mechanism 164 and includes an outer diameter or width ‘W13’ that is equal to or substantially equal to an inner diameter or width ‘W14’ of first biasing mechanism 164.

Viscoelastic/viscoplastic sleeve 162 further includes a length ‘L11’ that is equal to or substantially equal to a length ‘L12’ of biasing mechanism 164. As such, when a force ‘F’ acts upon ends 166 of first biasing mechanism 164 and ends 168 of sleeve 162, the behavior of damper element 160 includes both spring response characteristics and viscoelastic/viscoplastic response characteristics. Second biasing mechanism 165 includes a length ‘L13’ that is less than lengths ‘L11’ and ‘L12’. As such, once force ‘F’ compresses sleeve 162 and first biasing mechanism 164 a distance ‘D2’, the behavior of damper element 160 includes the spring response characteristics of both biasing mechanisms 164, 165 as well as viscoelastic/viscoplastic response characteristics.

Described herein are system and methods for dampening torsional vibration from a vehicle engine. A torsional damper assembly includes a damper element at least partially fabricated from a viscoelastic and/or viscoplastic material. The assembly provides the ability to tune the damping response characteristics thereof with an additional factor or parameter beyond that provided by a coil spring. A torsional damper at a resonance acts as a forced oscillator, and with the viscoelastic/viscoplastic damper element, the torsional damper acts as a forced damped oscillator.

A conventional torsion damper's damping force is translated to coil springs that require spring rates such that the damping force is suitable for the engine-to-transmission inertial coupling without bottoming-out the springs. The selection of spring rate may not be chosen to independently avoid forced oscillations that may cause false diagnostic detections and unwanted additional mechanical wear. However, addition of the viscoelastic/viscoplastic damper to the conventional torque damper spring configuration provides for the ability to tune both spring rate and viscoelastic/viscoplastic properties such that the primary action of the torsion damper is achieved through an implementation that can be independently tuned to avoid problematic oscillations by, for example, shifting the resonance where forced oscillation occurs to a frequency corresponding to a physically unavailable engine rotation rate (rpm).

In some instances, the torsional damper assembly described herein augments the conventional spring by the placement of a cord or rod of viscoelastic/viscoplastic material bound to the same or similar end surfaces that contain the ends of the springs and appearing in the middle of the springs. The viscoelastic/viscoplastic augmentation can be in the form of a stretched response or compressed response depending on the desired tuning features. The springs have elastic responses whereas the viscoelastic/viscoplastic materials have both spring-like elastic and dashpot-like viscus responses. For elastic responses, s=Ee where s is stress, e is strain, and E is their modulus. For viscus responses, s=n*de/dt where n is the viscosity.

As such, the torsional damper assembly described herein provides the ability to tune the force-response characteristics of the assembly independently of the spring reaction through the addition of viscoelastic/viscoplastic elements. A torsion damper reaction can be established to an input force that can be represented by both springs and dashpots (providing both elastic modulus and viscus viscosity values as tuning parameters rather than just elastic modulus). The spring response and dashpot response can be unique dimensions creating a surface of available response reactions from which the desired response function can be selected to independently provide optimized damping force to avoid spring bottom-out while accommodating the inertial interaction between an engine and transmission, and simultaneously avoiding unwanted resonant oscillation behavior that can cause false diagnostic detections and accelerated wear.

It should be understood that the mixing and matching of features, elements and/or functions between various examples may be expressly contemplated herein so that one skilled in the art would appreciate from the present teachings that features, elements and/or functions of one example may be incorporated into another example as appropriate, unless described otherwise above.

What is claimed is:

1. A torsional damper assembly for a vehicle, the torsional damper assembly configured to dampen torsional vibration transfer between an engine and a transmission of the vehicle, the torsional damper assembly comprising:
a hub having a flange defining a window;
an elastic biasing mechanism disposed at least partially within the window and configured to absorb a first portion of the torsional vibration from the engine;
a damper element disposed at least partially within the window and operatively associated with the elastic biasing mechanism, the damper element including a damper body formed from at least one of a viscoelastic material and a viscoplastic material;
wherein the damper body is configured to dampen a second, different portion of the torsional vibration from the engine and radial forces from the engine thereby reducing forced oscillation energy, and
wherein the damper body and the elastic biasing mechanism cooperatively dampen the first and second portions of torsional vibration transfer between the engine and the transmission.

2. The assembly of claim 1, wherein the biasing mechanism is configured to dampen the first portion of the torsional vibration transfer before the damper body dampens the second portion of the torsional vibration transfer.

3. The assembly of claim 1, further comprising a first plate and a second plate operatively associated with the hub, the first and second plates include first and second plate windows, respectively, each configured to at least partially align with the hub window.

4. The assembly of claim 3, wherein the first and second plates are disposed on opposite sides of the hub, and wherein the first and second windows are configured to each receive at least a portion of the damper body and the biasing mechanism.

5. The assembly of claim , wherein the biasing mechanism is an elastic spring.

6. The assembly of claim 5, wherein the damper body comprises a plurality of bands disposed about an outer diameter surface of the spring.

7. The assembly of claim 5, wherein the damper body is substantially cylindrical and the spring is embedded within the damper body.

8. The assembly of claim 5, wherein the damper body is a tubular sleeve, the spring disposed within the tubular sleeve.

9. The assembly of claim 8, further comprising a second spring disposed within an inner diameter of the spring.

10. The assembly of claim 9, wherein the spring has a first length and the second spring has a second length less than the first length.

11. The assembly of claim 5, wherein the damper body has a first length and the spring has as second length greater than the first length.

12. The assembly of claim 5, wherein the damper body has a first length and the spring has a second length substantially equal to the first length.

13. The assembly of claim 5, wherein the damper body is disposed within an inner diameter of the spring.

14. The assembly of claim 13, wherein the damper body includes an outer diameter substantially equal to the spring inner diameter.

15. The assembly of claim 13, wherein the damper body is a band having a width less than the spring inner diameter.
